(19) United States
(12) Patent Application Publication
(10) Pub. No.: US 2010/0071344 A1
(43) Pub. Date: Mar. 25, 2010

(54) Closed-circuit hydraulic thruster

(76) Inventor: Essam Tawfik Marcus, Morrisville, NC (US)

Correspondence Address: Essam T. Marcus, 124 Black Ridge Street, Morrisville, NC, 27560, US

(21) Appl. No.: 12/583,619

(22) Filed: Aug. 24, 2009

Related U.S. Application Data
(63) Continuation-in-part of application No. 12/284,513, filed on Sep. 23, 2008.

(51) Int. Cl. F03B 17/02

(52) U.S. Cl. 60/201

(57) ABSTRACT

The present invention provides closed-circuit hydraulic thruster used for the generation of thrust, or lift, force from the torque provided by a prime mover, or a motor. In a preferred embodiment the closed-circuit hydraulic thruster comprises an outer casing; at least two inner-members; at least one intermediate body; a drive shaft; at least one rotor assembly including a central disk and a plurality of circumferentially arranged, low angle of attack, hydrofoil-like blades; and an incompressible fluid completely filling the space enclosed within the casing. In operation, the incompressible fluid will circulate within the passages confined between the opposing surfaces of the casing, inner-members, and intermediate body due to its acceleration by the rotor blades, with the blades' generated thrust force being transmitted to the thruster's casing through thrust bearing arrangement(s) Means for cooling the incompressible viscous fluid are also provided.

### CROSS-REFERENCE TO RELATED APPLICATION(S)

This non-provisional utility patent application claims the benefit of one prior filed non-provisional application; the present application is a continuation-in-part of U.S. patent application Ser. No. 12/284,513, filed Sep. 23, 2008, which is incorporated herein by reference in its entirety.

### FIELD OF THE INVENTION

The present invention relates to a closed-circuit hydraulic thruster, and more particularly to a thrust, or lift, force generating hydraulic thruster with which the torque provided by a prime mover, or a motor, can be utilized efficiently in generating thrust, or lift, force, with said generated force being used for propelling, or lifting, a movable vehicle.

### BACKGROUND OF THE INVENTION

In the U.S. patent application Ser. No. 12/284,513, a closed-circuit hydraulic thruster (propeller) was disclosed, wherein a rotor having a plurality of hydrofoil-like blades, rotating within an incompressible viscous fluid filled casing, is used for the generation of thrust, or lift, force, utilizing the torque provided by a prime mover, or a motor. However, the before mentioned patent application did not clearly provide means allowing for the expansion of the incompressible viscous fluid, which will occur due to the heating up of the fluid, during operation.

Also, the before mentioned patent application did not provide dynamic seal means which will not fail at relatively low temperatures.

And thus, there is a need for a closed-circuit hydraulic thruster having means allowing for the expansion of its working fluid, and having dynamic seal means which will not fail at relatively low temperatures.

### BRIEF SUMMARY OF THE INVENTION

The present invention provides a closed-circuit hydraulic thruster used for generating thrust, or lift, force, utilizing the torque provided by a prime mover, or a motor, with said generated force being used in propelling, or lifting, a movable vehicle.

The present invention also provides a closed-circuit hydraulic thruster with which the amount of generated thrust, or lift, force may be flexibly changed within a relatively wide range.

The present invention further provides a closed-circuit hydraulic thruster having means allowing for the expansion of its working fluid during operation, and having dynamic seal means that will not fail at relatively low temperatures.

In a preferred embodiment, the closed-circuit hydraulic thruster (CCHT) comprises: an assembly having a generally oval-shaped outer casing portion, at least two inner-member portions, and at least one intermediate body portion fixedly attached to the outer casing and located intermediate of the outer casing and the inner-member portions, the outer casing structurally supports and encloses other thruster elements positioned therein, and the opposing surfaces of the casing portion, the at least two inner-member portions, and the at least one intermediate body portion define a closed-circuit fluid flow passage within the thruster; a drive shaft supported for rotation in a given direction inside the outer casing by an arrangement of bearings; at least one rotor secured for rotation with the drive shaft and lying in a plane normal to the rotational axis of the drive shaft, said rotor includes at least one central disk and a plurality of circumferentially arranged, low angle of attack, hydrofoil-like blades, each blade has an inner edge attached to the central disk, an outer edge, a leading edge, and a trailing edge, with each two successive blades being separated from each other by an intervening gap; an incompressible viscous fluid completely filling the space enclosed within the outer casing; means for sealing the space confined within the said outer casing; and at least one fluid expansion chamber.

The opposing surfaces of the intermediate-body and the outer casing define an outer annular passage therebetween, and the opposing surfaces of the intermediate-body(s) and the inner-members define an inner annular passage therebetween, with the rotor blades being positioned for rotation within the inner annular passage, and with the intermediate body(s) being configured to allow the flow of the incompressible viscous fluid from the outer annular passage to the upstream inflowing portion of the inner annular passage and from the downstream outflowing portion of the inner annular passage to the outer annular passage.

In a preferred embodiment, the downstream outflowing portion of the inner annular passage is provided with one set of circumferentially arranged vanes, with said vanes being configured to align the flow velocity vector of the accelerated working fluid during operation with the contour of the downstream portion of the annular passage. In another preferred embodiments, more than one successive sets of circumferentially arranged vanes are provided within the outflowing portion of the inner annular passage, with said vanes being configured to first decelerate the accelerated working fluid during operation, and then align its flow velocity vector with the annular passage contour.

The number of the blades of the rotor may range between 6 and 36 blades, depending on the amount of thrust, or lift, force to be generated by the thruster, with the ratio between the mean width of each of the gaps intervening between each two successive blades and the mean Chord length of each of the blades (the Gap/Blade ratio or G/B ratio) being determined according to the desired degree of deceleration of the working fluid within the downstream outflowing portion of the inner annular passage during operation, noting that the degree of deceleration will be proportional to the G/B ratio. In a preferred embodiment, the G/B ratio lies preferably anywhere within a range between 0.5:1 and 5:1, and more preferably between 1:1 and 4:1.

The successive parts of each blade are, either designed with the same angle of attack, or designed with gradually increasing angles of attack from the blade's outer edge to the blade's inner edge, so that the downstream flow of the working fluid will be homogenized in terms of total pressure. The blades cross sectional configuration and the angle of attack, or the selected range of angles of attacks, is chosen to provide optimum overall blade lift/drag ratio. Accordingly, in a preferred embodiment the angle of attack, or the angles of attacks of the successive parts of each blade, is/are chosen within a range of angles lying anywhere between 2 degrees and 14 degrees, and in a more preferred embodiment, the angle(s) of attack are chosen within a range of angles lying anywhere between 3 degrees and 8 degrees. Such design considerations are well known by people experienced in the Art.

In operation, the rotating, low angle of attack, hydrofoil-like blades will accelerate the incompressible fluid filling the CCHT's casing, which will result in the generation of lift-like force on the blades' surfaces in a direction normal to the plane of rotation of the blades, and a drag force in a direction parallel to the plane of rotation of the blades. The lift-like force will be transferred through the drive shaft to thrust bearings at the distal end of the drive shaft, which will transfer it to the CCHT's casing, and hence to the chassis of the propelled vehicle, while the drag force will be overcome by the driving torque. The CCHT will be oriented within the propelled vehicle so that this generated lift-like force will act in the intended direction of movement of the vehicle, i.e., the lift-like forces generated on the surfaces of the rotating blades will be used directly as the thrust force, and hence the term “generated thrust force” will be used herein after to refer to the “lift-like forces generated on the surfaces of the rotating blades”.

As the downstream accelerated working fluid will be deflected by the U-shaped curved part of the fluid flow passage downstream of the blades, which will generate an opposing reaction force on the inner surface of the said U-shaped curved part of the fluid flow passage, and as this opposing reaction force will partially neutralize the thrust force generated on the surfaces of the rotating blades, so, this opposing reaction force must be brought to a minimum to maximize the net effective thrust force generated by the CCHT.

Minimizing the opposing reaction force developed on the inner surface of the said U-shaped curved part of the fluid flow passage is provided by arranging for the deceleration of the working fluid accelerated by the rotating blades, and hence bringing its kinetic energy to a minimum, before it gets deflected within the curved part of the passage.

Deceleration of the accelerated working fluid is achieved by using hydrofoil-like blades having convex-shaped downstream displacing surfaces, and designing the CCHT's rotor with gaps between each two successive blades, so that the streamtubes representing the accelerated bodies of working fluid by each two successive blades will be diverging and separated from each other, which enables their divergent deceleration. This is aided by the use of a viscous incompressible fluid as the working fluid, so that we may benefit from the inherit deceleration properties of this type of fluids when it flows in a generally diverging streamlines.

The decelerated deflected working fluid will flow within the fluid flow passage within the CCHT's casing towards the upstream suction surfaces of the rotating blades, where they will be re-accelerated by the negative force developed on the upstream surfaces of the blades.

The rotor is either manufactured as a whole by forging or casting, or, the central disk of the rotor is forged or casted separately, with each blade, or each group of blades, being forged or casted separately, followed by assembling the rotor. Such manufacturing and assembling techniques are also well known by people experienced in the Art.

The thrust, or lift, force generated by the thruster's rotor is transmitted to the thruster's casing through one, or more than one, thrust bearing arrangements. Non limiting examples of thrust bearing arrangements for use include: fixed-geometry thrust bearings; and tilting pad thrust bearings.

In a preferred embodiment, the said drive shaft extends to a drive receiving end located outside the casing, through which the driving torque is supplied during operation, with the said sealing means being positioned in-between the opposing surfaces of the drive shaft and the casing. In another preferred embodiment, the drive shaft is geared to another intermediate shaft, with the said intermediate shaft extending to a drive receiving end located outside the casing, through which the driving torque is supplied during operation, and with the said sealing means being positioned in-between the opposing surfaces of the intermediate shaft and the casing.

In a preferred embodiment, the means for sealing the space confined between the opposing surfaces of the drive shaft, or the intermediate shaft, and the casing, comprises at least one set of O-ring seals; and at least one seal arrangement having at least one water-filled, generally torus-shaped, elastomeric tube, with the at least one elastomeric tube being co-axial with the thruster's drive shaft, and with the set of O-ring seals preferably including 1-3 successive O-rings.

In another preferred embodiment, the means for sealing the space confined between the opposing surfaces of the drive shaft, or the intermediate shaft, and the casing, comprises at least two axially stacked sets of O-ring seals; and at least one seal arrangement having at least one water-filled, generally torus-shaped, elastomeric tube, with the at least one elastomeric tube being co-axial with the thruster's drive shaft, and positioned intermediate of two of the O-ring sets. Each set of O-ring seals preferably includes 1-3 successive O-rings. In a preferred embodiment, the space between the successive sets of O-rings, wherein the water-filled elastomeric tube is positioned, is filled with a semisolid lubricant.

In a preferred embodiment, the said seal arrangement comprises: an inner ring, co-axial with the thruster's drive shaft, fixedly attached to the thruster's drive shaft, and having a circular concave groove formed on its circumferential outer surface; an outer generally ring-shaped portion, concentric with the inner ring, co-axial with the thruster's drive shaft, fixedly attached to the thruster's casing, and having a circular concave groove formed on its circumferential inner surface; and a water-filled, generally torus-shaped, elastomeric tube located within the space defined between the opposing surfaces of the circular concave groove formed on the circumferential outer surface of the inner ring and the circular concave groove formed on the circumferential inner surface of the outer ring-shaped portion, with the said elastomeric tube being pressly fitted to the circular concave groove formed on the circumferential inner surface of the outer ring-shaped portion.

This seal means arrangement will prevent the leakage of the working fluid at very low temperatures, at which O-ring seals fail, as the freezing of the water enclosed within the elastomeric tube, once the water freezing point is reached, will be associated with an increase in its volume, leading to expansion of the elastomeric tube, and thus pressing on the opposing surfaces of the circular concave grooves and blocking any potential leakage at that level. The elastomeric material used for manufacturing the O-rings and the elastomeric tube is chosen so that its elasticity will be maintained around the water freezing point. Non-limiting examples for such materials include Polyacrylate (ACM), and Epichlorohydrin (ECO).

In a preferred embodiment, the means for sealing the space confined between the opposing surfaces of the drive shaft, or the intermediate shaft, and the casing are fitted with heating means, to be used for warming up the sealing means before operating the thruster in relatively cold weather, to melt the ice formed within the elastomeric tubes and regain the elasticity of the elastomeric tube(s) and the O-ring seal(s) before starting, to safeguard against any leakage of the working fluid. In a preferred embodiment, thermometer means are provided in at least one point, within or around the seal means, and/or the heating means, to measure the temperature within the confines of the seal means, and to turn off the heating means once a preset temperature is reached.

In preferred embodiment, the fluid expansion chamber encloses a partially fluid-filled expansion space therein, and has at least one spring-loaded safety relief valve, and at least one spring-loaded suction valve for controlling the fluid flow between the fluid expansion space and the space enclosed within the thruster's casing. In a preferred embodiment, the fluid expansion chamber is completely sealed from surrounding atmosphere. In another preferred embodiment, the fluid expansion chamber has at least one passage for connecting it with the surrounding ambient air. In yet another preferred embodiment, the fluid expansion chamber has at least one spring-loaded safety relief valve, for controlling the release of the gases from the fluid expansion space once the pressure of gases within the fluid expansion space reaches to a preset value; and at least one spring-loaded suction valve, for controlling the admission of ambient air into the fluid expansion space once the pressure inside the fluid expansion space drops below a preset value. Also, in a preferred embodiment, at least one filter is provided at any level to prevent the ingestion of dirt, or dust, when air is admitted to the fluid expansion space, which may contaminate the working fluid.

In yet another preferred embodiment, the fluid expansion chamber comprises a first sub-chamber; and a second sub-chamber. The first sub-chamber is completely filled with fluid, and positioned intermediate of the second sub-chamber and the thruster's outer casing. The first sub-chamber has at least one spring-loaded safety relief valve and at least one spring-loaded suction valve for controlling the fluid flow between the first sub-chamber and the second sub-chamber; and at least one passage for connecting the space enclosed within the first sub-chamber with the space enclosed within the casing, with the second sub-chamber being partially filled with fluid. In a preferred embodiment, the second sub-chamber is completely sealed from surrounding atmosphere. In another preferred embodiment, the second sub-chamber has at least one passage for connecting the space enclosed within it with the surrounding ambient air. In yet another preferred embodiment, the second sub-chamber has at least one spring-loaded safety relief valve, for controlling the release of the gases from the second sub-chamber once the pressure of gases within the second sub-chamber reaches to a preset value; and at least one spring-loaded suction valve, for controlling the admission of ambient air into the second sub-chamber once the pressure inside the second sub-chamber drops below a preset value. Also, in a preferred embodiment, at least one filter is provided at any level to prevent the ingestion of dirt, or dust, when air is admitted to the fluid expansion chamber, which may contaminate the working fluid.

In a preferred embodiment, means for cooling the working fluid are provided. Said means may either provide passive cooling via a plurality of cooling ribs on the outer and/or inner surfaces of the thruster's casing, or provide active cooling by forced air or fluid cooling arrangements.

In a preferred embodiment, the closed-circuit hydraulic thruster comprises more than one rotor, with each rotor being secured for rotation with the drive shaft, and with each rotor lying in a plane normal to the rotational axis of the said drive shaft.

In a preferred embodiment, the means provided for driving the thruster's rotor comprises a prime mover, with the torque supplied by the prime mover transmitted to the thruster's drive shaft either directly, or indirectly through a gear train arrangement. In another preferred embodiment, the means provided for driving the thruster's rotor comprises an electric motor, with the torque supplied by it being transmitted to the thruster's drive shaft either directly, or indirectly through gear train arrangement, and with the electric motor's driving electric current being supplied from: at least one rechargeable electricity storage system, e.g. an electric battery or an ultracapacitor; a fuel cell; an electric generator driven by a prime mover; or any combination thereof.

In a preferred embodiment, an even number of thrusters is used, i.e. the thrusters are arranged in one or more pairs, with each pair of thrusters having counter-rotating rotors, to balance out the torque effect developed during operation.

In a preferred embodiment, the closed-circuit hydraulic thrusters are fixedly attached to the main frame of the propelled vehicle. In another preferred embodiment, the closed-circuit hydraulic thrusters are pivotally attached to the main frame of the propelled vehicle, to enable changing the direction in which the developed thrust/lift force is applied during operation.

### BRIEF DESCRIPTION OF THE SEVERAL VIEWS OF THE DRAWING

The description of the objects, features and advantages of the present invention, will be more fully appreciated by reference to the following detailed description of the exemplary embodiments in accordance with the accompanying drawings, wherein:

FIG. 1 is a sectional view in a schematic representation of an exemplary embodiment of a closed-circuit hydraulic thruster, in accordance with the present invention.

FIG. 2 is a cross sectional view, taken at the plane of line 2-2 in FIG. 1.

FIG. 3 is an enlarged view of the rotor of the embodiment of FIG. 1.

FIG. 4 is an enlarged sectional view, taken at the plane of line 4-4 in FIG. 3.

FIG. 5 is a cross sectional view, taken at the plane of line 5-5 in FIG. 1.

FIG. 6 is a partial sectional view in an enlarged schematic representation of the vanes provided within the downstream outflowing portion of the inner annular passage of the Closed-circuit hydraulic thruster of FIG. 1.

FIG. 7 is a partial sectional view in a schematic representation of the vanes provided within the downstream outflowing portion of the inner annular passage of another exemplary embodiment of a Closed-circuit hydraulic thruster in accordance with the present invention.

FIG. 8 is a sectional view in a schematic representation of another exemplary embodiment of a closed-circuit hydraulic thruster, in accordance with the present invention.

FIG. 9 is a sectional view in a schematic representation of another exemplary embodiment of a closed-circuit hydraulic thruster, in accordance with the present invention.

FIG. 10 is a sectional view in a schematic representation of an exemplary embodiment of sealing means in accordance with the present invention.

FIG. 11 is a sectional view in a schematic representation of an exemplary embodiment of a fluid expansion chamber in accordance with the present invention.

FIG. 12 is a sectional view in a schematic representation of another exemplary embodiment of a fluid expansion chamber in accordance with the present invention.

FIG. 13 is a sectional view in a schematic representation of another exemplary embodiment of a fluid expansion chamber in accordance with the present invention.

FIG. 14 is a sectional view in a schematic representation of another exemplary embodiment of a fluid expansion chamber in accordance with the present invention.

FIG. 15 is a sectional view in a schematic representation of another exemplary embodiment of a fluid expansion chamber in accordance with the present invention.

FIG. 16 is a schematic representation of a closed-circuit hydraulic thrusters-driving mechanism layout in accordance with the present invention.

FIG. 17 is a schematic representation of another closed-circuit hydraulic thrusters-driving mechanism layout in accordance with the present invention.

FIG. 18 is a schematic representation of another closed-circuit hydraulic thrusters-driving mechanism layout in accordance with the present invention.

FIG. 19 is a schematic representation of another closed-circuit hydraulic thrusters-driving mechanism layout in accordance with the present invention.

### DETAILED DESCRIPTION OF THE INVENTION

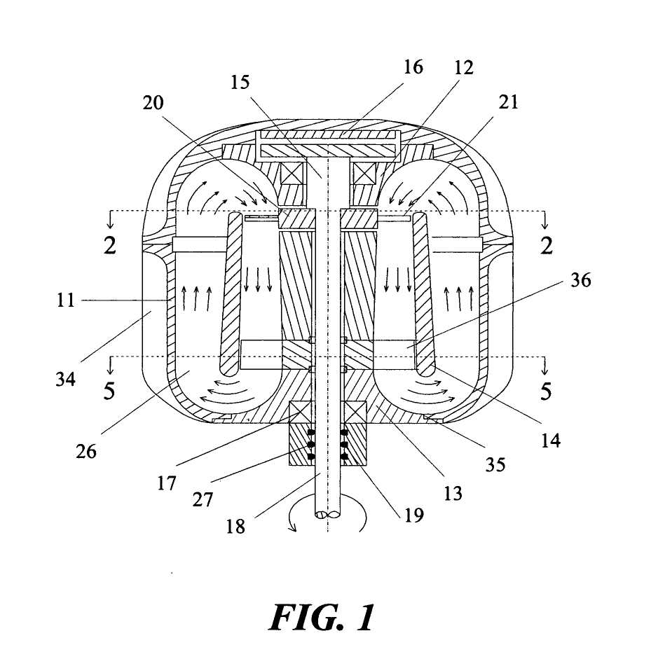

FIG. 1 is a sectional view in a schematic representation of an exemplary embodiment of a closed-circuit hydraulic thruster, in accordance with the present invention.

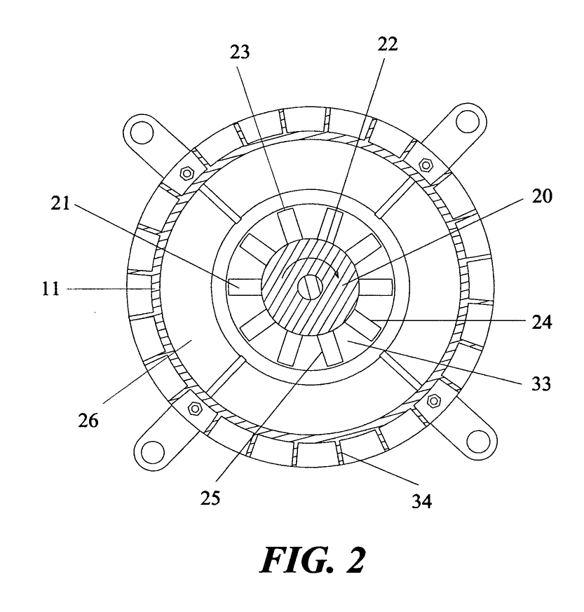

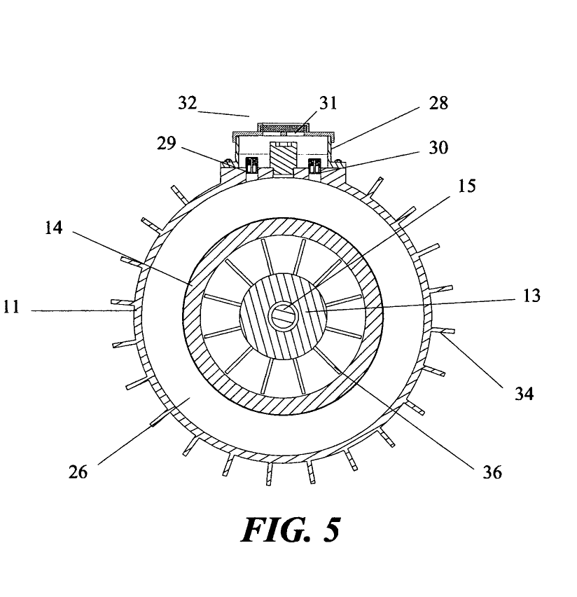

The closed-circuit hydraulic thruster (CCHT) comprises: an assembly having a generally oval-shaped outer casing portion (11), a first inner-member portion (12), a second inner-member portion (13), and one intermediate body portion (14) fixedly attached to the outer casing (11) and located intermediate of the outer casing (11) and the inner-member portions (12,13), the outer casing (11) structurally supports and encloses other thruster elements positioned therein, with the opposing surfaces of the casing portion (11), the two inner-member portions (12,13), and the intermediate body portion (14) defining a closed-circuit fluid flow passage within the thruster; a drive shaft (15) supported for rotation in a given direction inside the outer casing (11) by an arrangement of bearings (16,17) and extending to a drive receiving end (18) located outside the outer casing; a rotor secured for rotation with the drive shaft (15) and lying in a plane normal to the rotational axis of the drive shaft, said rotor includes a central disk (20) and a plurality of circumferentially arranged, low angle of attack, hydrofoil-like blades (21), and as also shown in FIG. 2, which is a cross sectional view taken at the plane of line 2-2 in FIG. 1, each blade has an inner edge (22) attached to the central disk (20), an outer edge (23), a leading edge (24), and a trailing edge (25), with each two successive blades being separated from each other by an intervening gap (33); an incompressible viscous fluid (26) completely filling the space enclosed within the outer casing (11); 3 O-ring seals (27) for sealing the space confined between the opposing surfaces of the drive shaft (15) and the outer casing (11); and, as also shown in FIG. 5, which is a cross sectional view taken at the plane of line 5-5 in FIG. 1, a fluid expansion chamber (28) enclosing a fluid expansion space therein, and having one spring-loaded safety relief valve (29), for controlling the release of the fluid (26) from the space enclosed within the outer casing (11), once the pressure of fluid (26) within the casing (11) reaches to a preset value, one spring-loaded suction valve (30), for controlling the admission of fluid from the fluid expansion chamber (28) into the space enclosed within the outer casing (11), once the pressure of fluid (26) within the casing (11) drops below a preset value, and one passage (31) for connecting the said fluid expansion chamber (28) with the surrounding ambient air (32).

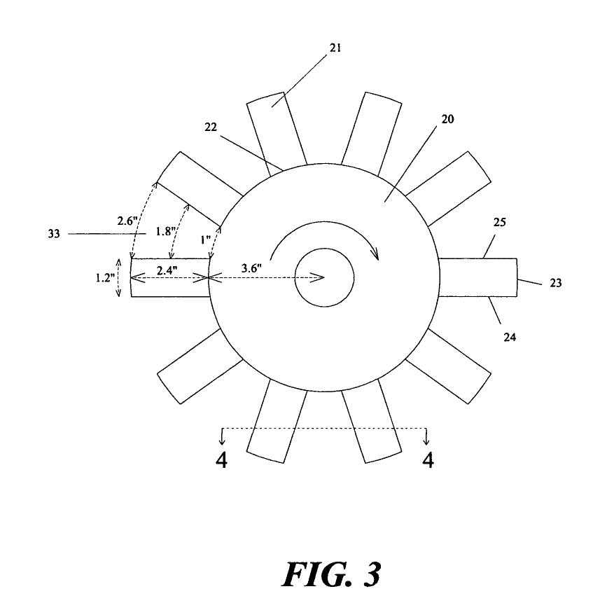

In this embodiment, as shown in FIG. 3, which is an enlarged view of the rotor of the embodiment of FIG. 1, the number of the blades (21) of the rotor is 10 blades, with each two successive blades being separated from each other by an intervening gap (33), with the ratio between the mean width of each of the gaps (33) and the mean Chord length of each of the blades (21), i.e. the Gap/Blade ratio or G/B ratio is 1.8:1.2, i.e. 1.5:1. As described herein above, the number of the blades of the rotor may range between 6 and 36 blades, depending on the amount of thrust, or lift, force to be generated by the thruster, with the used G/B ratio preferably lying anywhere between 0.5:1 and 5:1, and more preferably lying anywhere between 1:1 and 4:1.

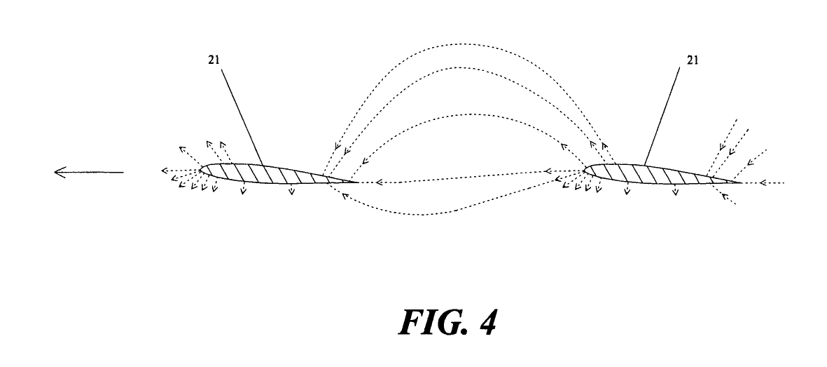

In this embodiment, the successive parts of each blade (21) have the same angle of attack. However, in other preferred embodiments, the blades may be designed with gradually increasing angles of attack from the blades outer edges to the blades inner edges, so that the downstream flow of the working fluid will be homogenized in terms of total pressure. And as shown in FIG. 4 is an enlarged sectional view, taken at the plane of line 4-4 in FIG. 3, the blades' (21) cross sectional profile is selected with a convex-shaped downstream displacing surface so that the accelerated working fluid by each blade during operation will be flowing in a generally diverging pattern. This generally diverging flow of the working fluid, aided by the gaps between the blades and the viscosity of the working fluid will decelerate the working fluid downstream of the blades, noting that the gaps between the successive blades will also minimize the interaction between them during operation, and thus will increase the net thrust force generated by the CCHT.

The selected angle(s) of attack is chosen to provide optimum overall blade lift/drag ratio. Accordingly, in a preferred embodiment the angle of attack, or the angles of attacks of the successive parts of each blade, is/are chosen within a range of angles lying anywhere between 2 degrees and 14 degrees, and in a more preferred embodiment, the angle(s) of attack are chosen within a range of angles lying anywhere between 3 degrees and 8 degrees. Such design considerations are well known by people experienced in the Art.

The rotor is either manufactured as a whole by forging or casting, or, the central disk (20) of the rotor is forged or casted separately, with each blade (21), or each group of blades, being forged or casted separately, followed by assembling the rotor. Such manufacturing and assembling techniques are also well known by people experienced in the Art.

The thrust, or lift, force generated by the thruster's rotor is transmitted to the thruster's casing (11) through one, or more than one, thrust bearing arrangement (16). Non limiting examples of thrust bearing arrangements for use include: fixed-geometry thrust bearings; and tilting pad thrust bearings.

In this embodiment, the outer surface of the thruster's casing (11) is provided with a plurality of cooling ribs (34) to cool the working fluid (26) during operation.

In operation, the working fluid (26) will be accelerated by the rotating convex-shaped downstream displacing surfaces of the blades (21), and hence the sub-streams of the accelerated working fluid by each two adjacent blades will be diverging, and will be separated from each other due to the gaps (33) between the blades. This separation between the diverging sub-streams of the accelerated working fluid along with the viscosity of the working fluid will lead to deceleration of the working fluid, along with partial damping of its non-axial vector components, so that the main bulk of the kinetic energy added to the working fluid (26) through acceleration by the blades (21) will be dissipated and converted into heat, with the downstream portion of the inner fluid flow passage being provided with one set of circumferentially arranged vanes (36) to align the flow velocity vector of the accelerated working fluid during operation with the contour of the downstream portion of the annular passage.

The decelerated working fluid will be directed to the upstream portion of the inner fluid flow passage, where it will be accelerated by the effect of the suction force generated on the rotating upstream suction surfaces of the blades (21).

The net thrust, or lift, force provided by the closed-circuit hydraulic thruster of the present invention will be equivalent to the total thrust, or lift, force generated by the blades (21) minus the net reaction force acting on the U-shaped walls defining the curved parts (35) of the inner walls of the casing (11), and thus, to maximize the net thrust, or lift, force we need to optimize the total thrust, or lift, force generated by the blades (21) and minimize the net reaction force acting on the walls defining the curved parts (35) of the inner walls of the casing (11).

Optimizing the total thrust, or lift, force generated by the blades (21) is provided by selecting the proper blades cross-sectional profile; the optimum angle(s) of attack for use with the selected blades cross-sectional profile; and the proper type of incompressible viscous working fluid (26) having relatively low dynamic viscosity.

Minimizing the net reaction force acting on the U-shaped walls confining the curved parts (35) of the fluid passage is provided by bringing down the kinetic energy within the working fluid (26) to a minimum before it is deflected by the inner walls of the casing (11). This will depend on the configuration of the thruster's casing (11); the G/B ratio; and the viscosity of the working fluid (26).

During operation, the heating of the working fluid (26) will lead to a proportional increase in its volume, with the excess volume of the working fluid flowing to the fluid expansion chamber (28) through the spring-loaded safety relief valve (29) connecting the fluid expansion chamber (28) with the space enclosed within the outer casing (11), once a preset pressure level is reached. This will safeguard against the formation of cavitations on the blades' (21) suction surfaces at relatively high operating speeds. The preset pressure level at which the excess pressure will be relieved through the safety relief valve (29), is selected to be lower than the sealing pressure limit of the used O-ring seals (27), and will depend on the spring loading of the used safety relief valve (27).

When not in operation, the cooling of the working fluid (26) will lead to a proportional decrease in its volume, with the working fluid moving back from the fluid expansion chamber (28) to the space enclosed within the outer casing (11), through the spring-loaded suction valve (30). The passage (31) connecting the fluid expansion chamber (28) with the surrounding ambient air (32) is provided with a filter, to prevent the ingestion of dirt, or dust, through the suction valve (30), which may contaminate the working fluid.

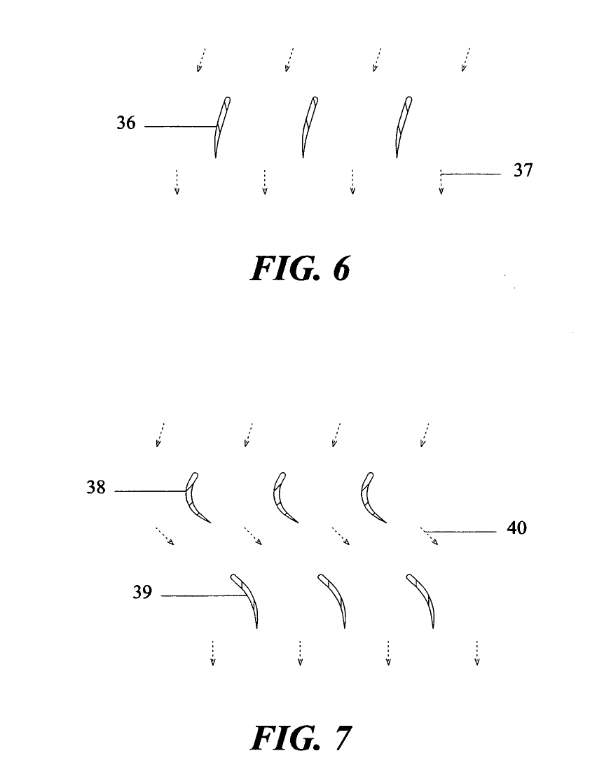

FIG. 6 is a partial sectional view in an enlarged schematic representation of the vanes provided within the downstream outflowing portion of the inner annular passage of the Closed-circuit hydraulic thruster of FIG. 1.

In this embodiment, one set of circumferentially arranged vanes (36) is provided, with said vanes being configured to align the flow velocity vector of the accelerated working fluid (37) with the contour of the downstream portion of the inner annular passage of the Closed-circuit hydraulic thruster during operation.

FIG. 7 is a partial sectional view in a schematic representation of the vanes provided within the downstream outflowing portion of the inner annular passage of another exemplary embodiment of a Closed-circuit hydraulic thruster in accordance with the present invention.

In this embodiment, two successive sets of circumferentially arranged vanes (38, 39) are provided, with said vanes being configured to direct the flow of the accelerated working fluid (40) in a generally tortuous course, so that the working fluid will be further decelerated within the vanes, with a portion of its kinetic energy being converted into heat. This will further minimize the reaction force acting on the walls defining the U-shaped curved parts of the inner walls of the CCHT casing downstream of the blades, and thus, maximizing the net developed thrust force.

The outflowing portion of the distal set of vanes is also configured to align the flow velocity vector of the accelerated working fluid with the contour of the downstream portion of the inner annular passage of the Closed-circuit hydraulic thruster during operation.

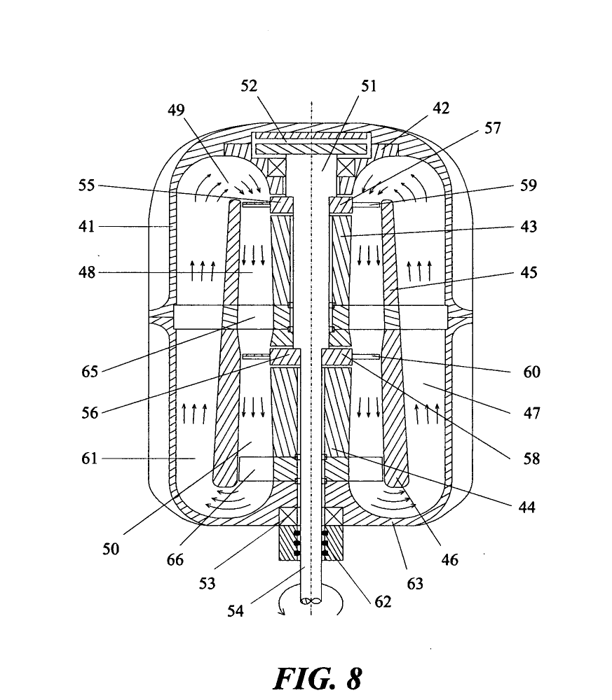

FIG. 8 is a sectional view in a schematic representation of another exemplary embodiment of a closed-circuit hydraulic thruster, in accordance with the present invention.

The closed-circuit hydraulic thruster comprises: an assembly having a generally oval-shaped outer casing portion (41), three inner-member portions (42,43,44), and an intermediate body portion (45) fixedly attached to the outer casing (41) and located intermediate of the outer casing (41) and the inner-member portions (42,43,44), the outer casing (41) structurally supports and encloses other thruster elements positioned therein, with the opposing surfaces of the casing portion (41), the inner-member portions (42,43,44), and the intermediate body portion (45) defining a closed-circuit fluid flow passage within the thruster wherein the opposing surfaces of the intermediate body portion (45) and the casing portion (41) defining an outer annular passage (47) therebetween, and with the opposing surfaces of the intermediate body portion (45) and the inner-member portions (42,43,44) defining an inner annular passage (48) therebetween, said inner annular passage has an upstream inflowing converging portion (49) and a downstream outflowing diverging portion (50); a drive shaft (51) supported for rotation in a given direction inside the outer casing (41) by an arrangement of bearings (52,53) and extending to a drive receiving end (54) located outside the outer casing; two rotors (55,56), each secured for rotation with the drive shaft (51) and each lying in a plane normal to the rotational axis of the drive shaft (51), each rotor includes a central disk (57,58) and a plurality of circumferentially arranged, low angle of attack, hydrofoil-like blades (59,60), with the blades being positioned for rotation within said inner annular passage (48); an incompressible viscous fluid (61) filling the space enclosed within the outer casing (41), with the intermediate body portion (45) being configured to allow the flow of said incompressible viscous fluid (61) from the outer annular passage (47) to the upstream inflowing portion of the inner annular passage (49) and from said downstream outflowing portion of the inner annular passage (50) to said outer annular passage (47); sealing means including three O-ring seals (62), for sealing the space confined between the opposing surfaces of the drive shaft (51) and the outer casing (41); and a fluid expansion chamber, which is not shown in this cross sectional view.

The design parameters for each of the rotors (55,56) in this embodiment, as well as other thruster's design and manufacturing considerations are similar to the ones described herein above in reference to the embodiment of FIG. 1.

In operation, the working fluid (61) will be accelerated by the rotating downstream displacing surfaces of the blades (59) of the first rotor (55), followed by downstream deceleration of the working fluid, as described herein above. The decelerated working fluid will be re-accelerated by the suction surfaces of the blades (60) of the second rotor (56) followed by further acceleration by the rotating downstream displacing surfaces of the blades (60) of the second rotor (56), which is followed by downstream deceleration of the working fluid, before it is directed through the outer annular passage (47) to the upstream inflowing portion (49) of the inner annular passage.

In this embodiment, the net thrust, or lift, force provided by the closed-circuit hydraulic thruster of the present invention will be equivalent to the total thrust, or lift, force generated by the blades (59,60) of the two rotors (55,56) minus the net reaction force acting on the walls defining the curved parts (63) of the casing (41). Also, in this embodiment, two sets of circumferentially arranged vanes (65,66) are provided, each downstream of the blades (59,60) of one of the rotors (55,56) to align the flow velocity vector of the accelerated working fluid during operation with the contour of the downstream portions of the annular passage.

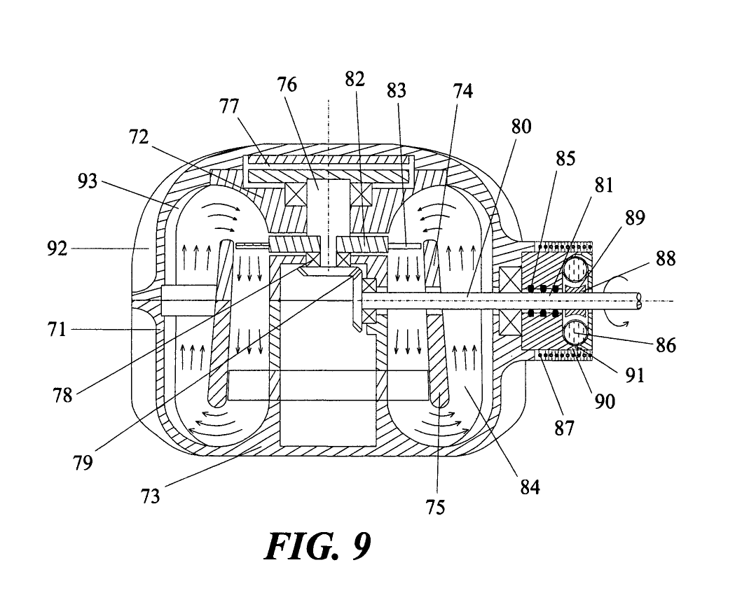

FIG. 9 is a sectional view in a schematic representation of another exemplary embodiment of a closed-circuit hydraulic thruster, in accordance with the present invention.

The closed-circuit hydraulic thruster comprises: an assembly having a generally oval-shaped outer casing portion (71), a first inner-member portion (72), and a second inner-member portion (73), and two intermediate body portions (74,75) fixedly attached to the outer casing (71) and located intermediate of the outer casing (71) and the inner-member portions (72,73), the outer casing (71) structurally supports and encloses other thruster elements positioned therein, with the opposing surfaces of the casing portion (71), the inner-member portions (72,73), and the intermediate body portions (74,75) defining a closed-circuit fluid flow passage within the thruster; a drive shaft (76) supported for rotation in a given direction inside the outer casing (71) by an arrangement of bearings (77,78) and geared (79) to another intermediate shaft (80), with the said intermediate shaft (80) extending to a drive receiving end (81) located outside the casing (71), through which the driving torque is supplied during operation; a rotor secured for rotation with the drive shaft (76) and lying in a plane normal to the rotational axis of the drive shaft, said rotor includes a central disk (82) and a plurality of circumferentially arranged, low angle of attack, hydrofoil-like blades (83), each blade has an inner edge attached to the central disk (82), an outer edge, a leading edge, and a trailing edge; an incompressible viscous fluid (84) filling the space enclosed within the outer casing (71); sealing means including one set of O-ring seals (85), and a seal arrangement having one water-filled, generally torus-shaped, elastomeric tube (86) co-axial with the intermediate shaft (80) and positioned distal to the set of the O-ring seals (85), for sealing the space confined between the opposing surfaces of the intermediate shaft (80) and the outer casing (71), with a heating coil (87) fitted on the outer surface of the sealing means, for warming up the O-ring seals (85) and the elastomeric tube (86), as needed; and a fluid expansion chamber, which is not shown in this cross sectional view.

The design parameters for the rotor in this embodiment, as well as other thruster's design, operating, and manufacturing considerations are similar to the ones described herein above in reference to the embodiment of FIG. 1.

In this embodiment, the said seal arrangement comprises: an inner ring (88) co-axial with the intermediate shaft (80), fixedly attached to the intermediate shaft (80), and having a circular concave groove (89) formed on its circumferential outer surface; an outer generally ring-shaped portion (90), concentric with the inner ring (88), co-axial with the intermediate shaft (80), fixedly attached to the thruster's casing (71), and having a circular concave groove (91) formed on its circumferential inner surface; and a water-filled, generally torus-shaped, elastomeric tube (86) located within the space defined between the opposing surfaces of the circular concave groove (89) and the circular concave groove (91), with the said elastomeric tube (86) being pressly fitted to the circular concave groove (91) formed on the circumferential inner surface of the outer ring-shaped portion (90).

The combined use of the O-ring seals (85) and the water-filled, generally torus-shaped, elastomeric tube (86), for sealing the space confined between the opposing surfaces of the intermediate shaft (80) and the outer casing (71), will prevent the leakage of the working fluid, through the seal, at very low temperatures at which O-ring seals fail, as the freezing of the water enclosed within the elastomeric tube (86), once the water freezing point is reached, will be associated with an increase in its volume, leading to expansion of the elastomeric tube (86), and thus pressing on the opposing surfaces of the circular concave grooves (89,91) and blocking any potential leakage at that level. The elastomeric material used for manufacturing the O-rings (85) and the elastomeric tube (86) is chosen so that its elasticity will be maintained around the water freezing point. Non-limiting examples for such materials include Polyacrylate (ACM), and Epichlorohydrin (ECO).

The heating coil (87) fitted on the outer surface of the sealing means, i.e. the O-rings (85) and the elastomeric tube (86), will enable warming up the sealing means before operating the thruster in relatively cold weather, to melt the ice formed within the elastomeric tube (86), and regain the elasticity of the elastomeric tube and the O-ring seals before starting, to safeguard against any leakage of the working fluid (84). In this embodiment, two thermometers are provided to measure the temperature at two points within the confines of the seal means, and to turn off the heating coil (87) once a preset temperature is reached (not shown in the drawing for simplicity).

Also, in this embodiment, cooling ribs are provides on the outer surface (92), and on the inner surface (93), of the outer casing (71), to improve the rate of cooling of the working fluid (84) during operation.

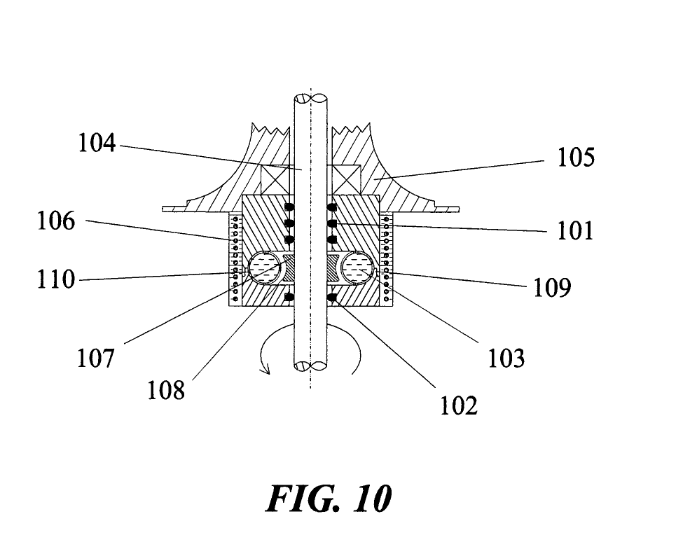

FIG. 10 is a sectional view in a schematic representation of an exemplary embodiment of sealing means in accordance with the present invention.

In this embodiment, the sealing means include two axially stacked sets of O-ring seals (101, 102), and a seal arrangement having one water-filled, generally torus-shaped, elastomeric tube (103) co-axial with the drive shaft (104) and positioned intermediate of the two sets of the O-ring seals (101, 102), for sealing the space confined between the opposing surfaces of the drive shaft (104) and the outer casing (105), with a heating coil (106) fitted on the outer surface of the sealing means, for warming up the O-ring seals (101, 102) and the elastomeric tube (103), when needed. The seal arrangement comprises: an inner ring (107) co-axial with the drive shaft (104), fixedly attached to the drive shaft (104), and having a circular concave groove (108) formed on its circumferential outer surface; an outer generally ring-shaped portion (109), concentric with the inner ring (107), co-axial with the drive shaft (104), fixedly attached to the thruster's casing (105), and having a circular concave groove (110) formed on its circumferential inner surface; and a water-filled, generally torus-shaped, elastomeric tube (103) located within the space defined between the opposing surfaces of the circular concave groove (108) and the circular concave groove (110), with the said elastomeric tube (103) being pressly fitted to the circular concave groove (110) formed on the circumferential inner surface of the outer ring-shaped portion (109).

The combined use of two sets of O-ring seals (101,102) and the water-filled, generally torus-shaped, elastomeric tube (103), for sealing the space confined between the opposing surfaces of the drive shaft (104) and the outer casing (105), will prevent the leakage of the working fluid, through the seal, at very low temperatures at which O-ring seals fail, as the freezing of the water enclosed within the elastomeric tube (103), once the water freezing point is reached, will be associated with an increase in its volume, leading to expansion of the elastomeric tube (103), and thus pressing on the opposing surfaces of the circular concave grooves (108,110) and blocking any potential leakage at that level. In this embodiment, the proximal O-ring set (101) has 3 successive O-rings, while the distal O-ring set (102) has only one O-ring, with the space between the two sets of O-rings (101, 102), wherein the water-filled elastomeric tube (103) is positioned, is filled with a semisolid lubricant.

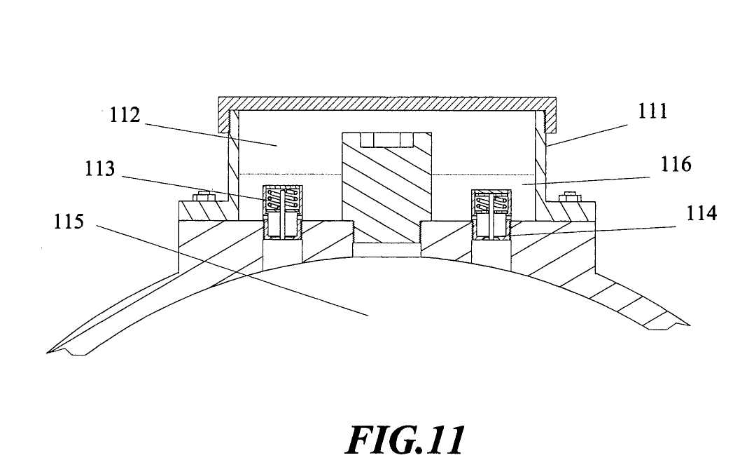

FIG. 11 is a sectional view in a schematic representation of an exemplary embodiment of a fluid expansion chamber in accordance with the present invention.

In this embodiment, the fluid expansion chamber (111) encloses a partially-filled fluid expansion space (112) therein, and has one spring-loaded safety relief valve (113) and one spring-loaded suction valve (114) for controlling the fluid flow between the fluid expansion space (112) and the space enclosed within the thruster's casing (115), with the fluid expansion space (112) being completely sealed from surrounding atmosphere.

In operation, the heating of the working fluid (116) will lead to a proportional increase in its volume, with the excess volume of the working fluid flowing to the fluid expansion space (112) through the safety relief valve (113). This will lead to a proportional increase in the pressure of the air trapped within the fluid expansion space (112). When not in operation, the cooling of the working fluid (116) will lead to a proportional decrease in its volume, with the working fluid moving back from the fluid expansion space (112) to the space enclosed within the outer casing (115), through the suction valve (114), as described herein above.

This preferred embodiment will be convenient for use in the applications wherein the closed-circuit hydraulic thruster will not be maintained in a leveled horizontal position during operation, as it will safeguard against any leak of the working fluid (116).

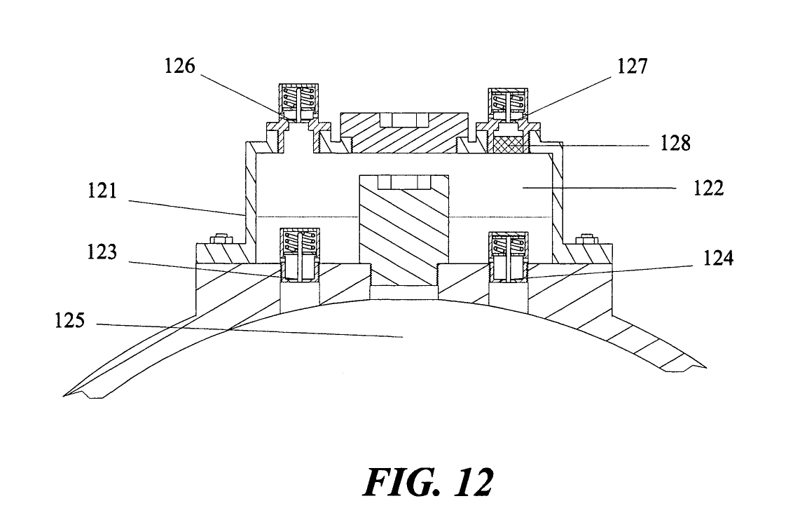

FIG. 12 is a sectional view in a schematic representation of another exemplary embodiment of a fluid expansion chamber in accordance with the present invention.

In this embodiment, the fluid expansion chamber (121) encloses a partially-filled fluid expansion space (122) therein, and has one spring-loaded safety relief valve (123) and one spring-loaded suction valve (124) for controlling the fluid flow between the fluid expansion space (122) and the space enclosed within the thruster's casing (125); one spring-loaded safety relief valve (126), for controlling the release of the gases from the fluid expansion space (122) once the pressure of gases within the fluid expansion space reaches to a preset value; and one spring-loaded suction valve (127), for controlling the admission of ambient air into the fluid expansion space (122) once the pressure inside the fluid expansion space drops below a preset value, with the said suction valve (127) being provided with a filter (128) to prevent the ingestion of dirt, or dust, when air is admitted to the fluid expansion space (122), which may contaminate the working fluid.

In operation, the heating of the working fluid will lead to a proportional increase in its volume, with the excess volume of the working fluid flowing to the fluid expansion space (122) through the safety relief valve (123) connecting the space enclosed within the fluid expansion space (122) with the space enclosed within the outer casing (125). This will increase the pressure of the gases trapped within the fluid expansion space (122) till a preset pressure is reached at which excess pressure is relieved through the safety relief valve (126).

When not in operation, the cooling of the working fluid will lead to a proportional decrease in its volume, with the working fluid moving back from the fluid expansion space (122) to the space enclosed within the outer casing (125), through the suction valve (124). In very cold weather, the excessive decrease in the volume of the working fluid will initially decrease the pressure within the fluid expansion space (122) below ambient air pressure, which will be brought back to normal through the opening of the suction valve (127).

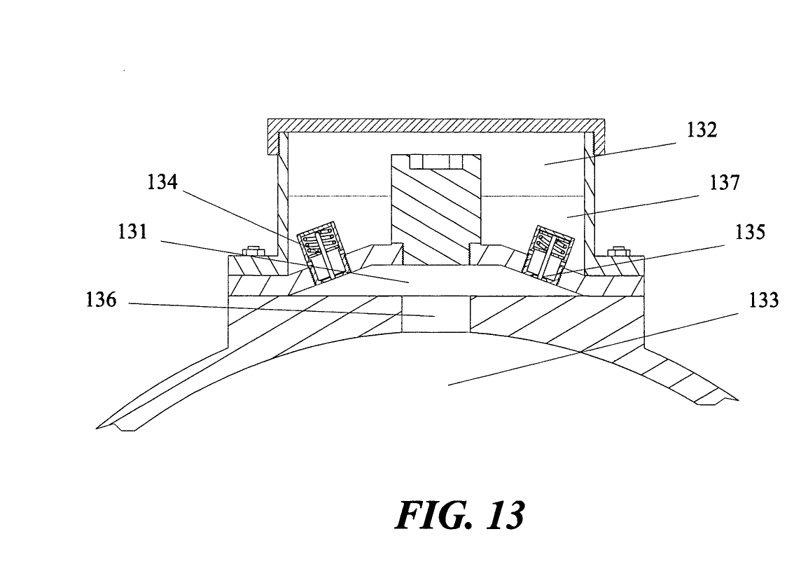

FIG. 13 is a sectional view in a schematic representation of another exemplary embodiment of a fluid expansion chamber in accordance with the present invention.

In this embodiment, the fluid expansion chamber comprises a first sub-chamber (131); and a second sub-chamber (132). The first sub-chamber (131) is completely filled with fluid, and positioned intermediate of the second sub-chamber (132) and the thruster's outer casing (133). The first sub-chamber (131) has one spring-loaded safety relief valve (134) and one spring-loaded suction valve (135) for controlling the fluid flow between the first sub-chamber (131) and the second sub-chamber (132); and one passage (136) for connecting the space enclosed within the first sub-chamber (131) with the space enclosed within the said outer casing (133). The second sub-chamber is partially filled with fluid (137), and is completely sealed from surrounding atmosphere.

In operation, the heating of the working fluid will lead to a proportional increase in its volume, with the excess volume of the working fluid flowing to the first sub-chamber (131) through the passage (136) connecting the space enclosed within it with the space enclosed within the outer casing (133). This will increase the pressure of the fluid within the first sub-chamber (131), leading to a proportional flow of the fluid from the first sub-chamber (131) to the second sub-chamber (132) through the safety relief valve (134).

When not in operation, the cooling of the working fluid will lead to a proportional decrease in its volume, with the working fluid moving back from the first sub-chamber (131) to the space enclosed within the outer casing (133), which will be associated with an equivalent flow of fluid from the second sub-chamber (132) to the first sub-chamber (131), through the suction valve (135).

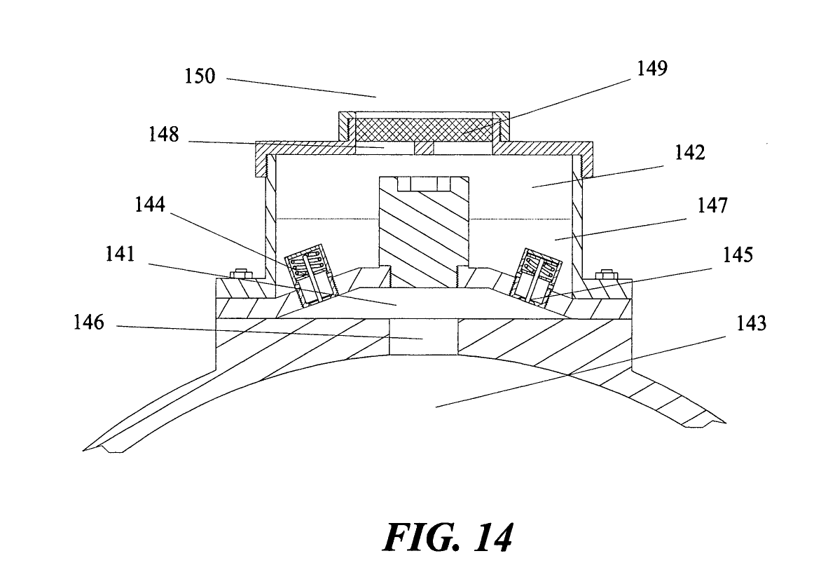

FIG. 14 is a sectional view in a schematic representation of another exemplary embodiment of a fluid expansion chamber in accordance with the present invention.

In this embodiment, the fluid expansion chamber comprises a first sub-chamber (141); and a second sub-chamber (142). The first sub-chamber (141) is completely filled with fluid, and positioned intermediate of the second sub-chamber (142) and the thruster's outer casing (143). The first sub-chamber (141) has one spring-loaded safety relief valve (144); one spring-loaded suction valve (145) for controlling the fluid flow between the first sub-chamber (141) and the second sub-chamber (142); and one passage (146) for connecting the space enclosed within the first sub-chamber (141) with the space enclosed within the said outer casing (143). The second sub-chamber is partially filled with fluid (147), and has two passages (148) for connecting the space enclosed within the second sub-chamber (142) with the surrounding ambient air, with the said passages (148) being provided with filtration means (149) to prevent the ingestion of dirt, or dust, when air is admitted to the fluid expansion chamber.

In operation, the heating of the working fluid will lead to a proportional increase in its volume, with the excess volume of the working fluid flowing to the first sub-chamber (141) through the passage (146) connecting the space enclosed within it with the space enclosed within the outer casing (143). This will increase the pressure of the fluid within the first sub-chamber (141), leading to a proportional flow of the fluid from the first sub-chamber (141) to the second sub-chamber (142) through the safety relief valve (144). This will be followed by a proportional flow of gases from the second sub-chamber (142) to the surrounding atmosphere (150), through the passages (148), which will keep the pressure of gases within the second sub-chamber (142) around ambient atmospheric level.

When not in operation, the cooling of the working fluid will lead to a proportional decrease in its volume, with the working fluid moving back from the first sub-chamber (141) to the space enclosed within the outer casing (143), which will be associated with an equivalent flow of fluid from the second sub-chamber (142) to the first sub-chamber (141), through the suction valve (145). In very cold weather, the excessive decrease in the volume of the working fluid will initially decrease the pressure within the second sub-chamber (142) below ambient air pressure, which will be brought back to normal through the passage (148) connecting the second sub-chamber (142) with surrounding ambient air.

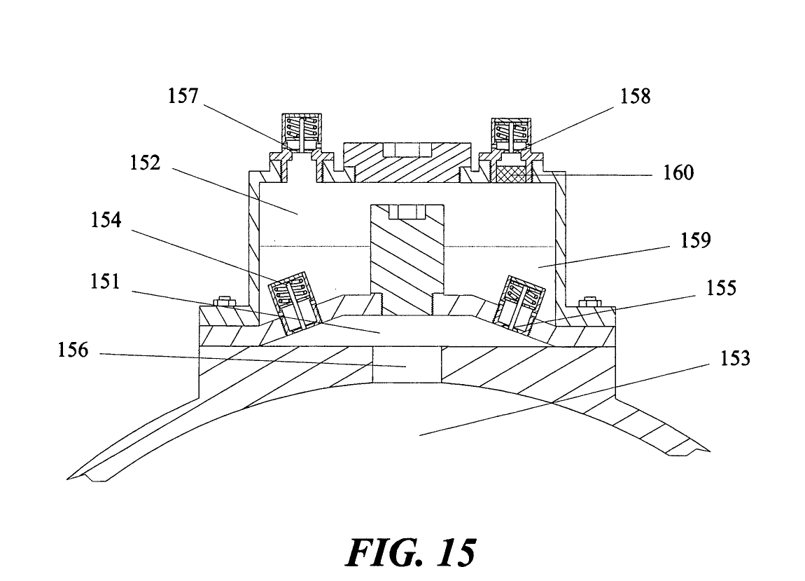

FIG. 15 is a sectional view in a schematic representation of another exemplary embodiment of a fluid expansion chamber in accordance with the present invention.

In this embodiment, the fluid expansion chamber comprises a first sub-chamber (151); and a second sub-chamber (152). The first sub-chamber (151) is completely filled with fluid, and positioned intermediate of the second sub-chamber (152) and the thruster's outer casing (153). The first sub-chamber (151) has one spring-loaded safety relief valve (154) and one spring-loaded suction valve (155) for controlling the fluid flow between the first sub-chamber (151) and the second sub-chamber (152); and one passage (156) for connecting the space enclosed within the first sub-chamber (151) with the space enclosed within the said outer casing (153). The second sub-chamber is partially filled with fluid (159), and has one spring-loaded safety relief valve (157), for controlling the release of the gases from the second sub-chamber (152) once the pressure of gases within the second sub-chamber (152) reaches to a preset value, and one spring-loaded suction valve (158), for controlling the admission of ambient air into the second sub-chamber (152) once the pressure inside the second sub-chamber (152) drops below a preset value, with the said suction valve (158) being provided with filtration means (160) to prevent the ingestion of dirt, or dust, when air is admitted to the fluid expansion chamber.

In operation, the heating of the working fluid will lead to a proportional increase in its volume, with the excess volume of the working fluid flowing to the first sub-chamber (151) through the passage (156) connecting the space enclosed within it with the space enclosed within the outer casing (153). This will increase the pressure of the fluid within the first sub-chamber (151), leading to a proportional flow of the fluid from the first sub-chamber (151) to the second sub-chamber (152) through the safety relief valve (154). The fluid flow from the first sub-chamber (151) to the second sub-chamber (152) will increase the pressure of the gases trapped within the second sub-chamber (152) till a preset pressure is reached at which excess pressure is relieved through the safety relief valve (157).

When not in operation, the cooling of the working fluid will lead to a proportional decrease in its volume, with the working fluid moving back from the first sub-chamber (151) to the space enclosed within the outer casing (153), which will be associated with an equivalent flow of fluid from the second sub-chamber (152) to the first sub-chamber (151), through the suction valve (155). In very cold weather, the excessive decrease in the volume of the working fluid will initially decrease the pressure within the second sub-chamber (152) below ambient air pressure, which will be brought back to normal through the opening of the suction valve (158).

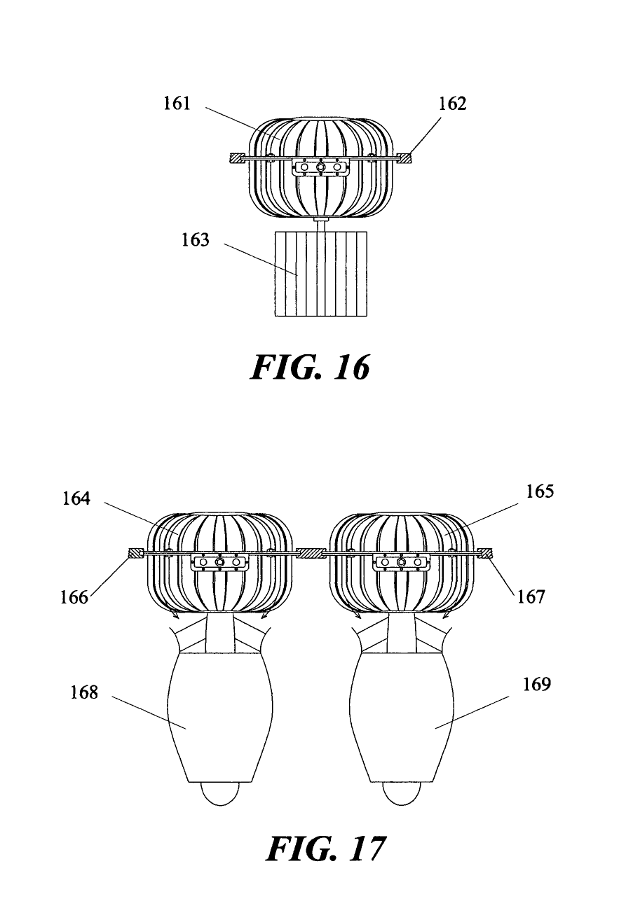

FIG. 16 is schematic representation of a closed-circuit hydraulic thrusters-driving mechanism layout in accordance with the present invention, wherein a single closed circuit hydraulic thruster (161) fixedly attached to the main frame (162) of the propelled vehicle is used, with the driving torque being supplied to it from an electric motor (163).

FIG. 17 is a schematic representation of another closed-circuit hydraulic thrusters-driving mechanism layout in accordance with the present invention, wherein two closed-circuit hydraulic thrusters (164,165) are used, each fixedly attached to the main frame (166,167) of the propelled vehicle, and each driven by a separate prime mover (168,169), with gas turbine engines being used as the driving prime movers.

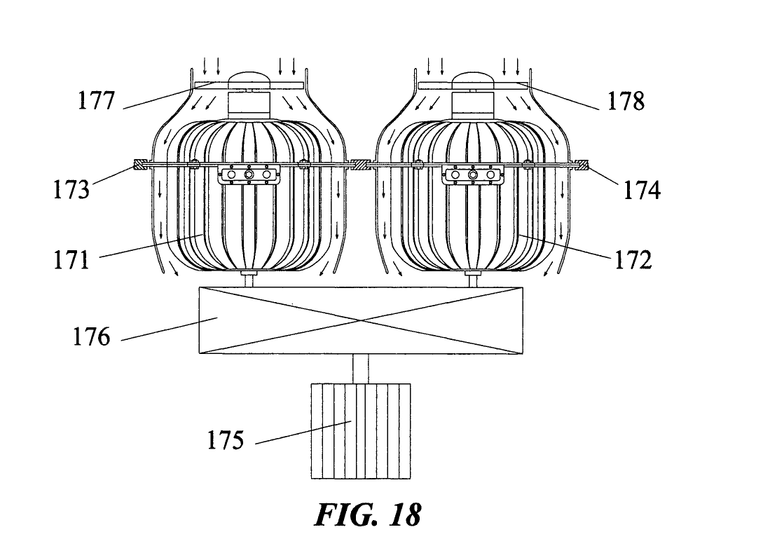

FIG. 18 is a schematic representation of another closed-circuit hydraulic thrusters-driving mechanism layout in accordance with the present invention, wherein two closed-circuit hydraulic thrusters (171,172) are used, each fixedly attached to the main frame (173,174) of the propelled vehicle, and both driven by an electric motor (175), with the torque supplied by the electric motor (175) being transmitted to the thruster's drive shaft through a gear train arrangement (176). In this embodiment, each closed-circuit hydraulic thruster is provided with forced-air cooling means (177,178) for augmented cooling of the thrusters, when needed.

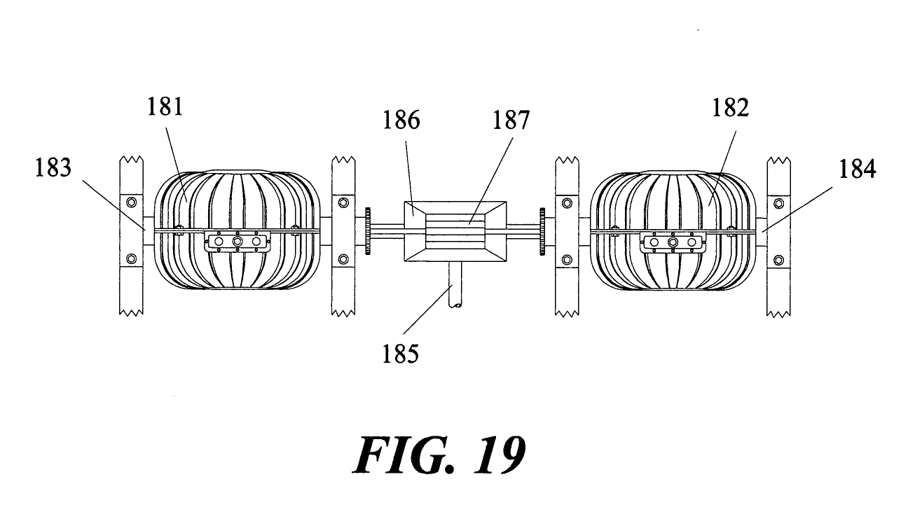

FIG. 19 is a schematic representation of another closed-circuit hydraulic thrusters-driving mechanism layout in accordance with the present invention, wherein two closed-circuit hydraulic thrusters (181,182) are used, each pivotally attached to the main frame (183,184) of the propelled vehicle, and both driven by a prime mover, or an electric motor, with the torque (185) supplied by the prime mover, or the electric motor, being transmitted to the thruster's drive shaft through a gear train arrangement (186). This arrangement will enable changing the direction in which the developed thrust/lift force is applied during operation, through a stepper motor (187), or the like.

Further objectives and advantages of the present invention will be apparent to those skilled in the art from the detailed description of the disclosed invention. The present discussion of illustrative embodiments is not intended to limit the spirit and scope of the invention beyond that specified by the claims presented hereafter.

What is claimed is:

1. A closed-circuit hydraulic thruster used for generating thrust, or lift, force, utilizing the torque provided by a prime mover, or an electric motor, with said generated force being used in propelling, or lifting, a movable vehicle, said closed-circuit hydraulic thruster comprises:
an assembly having a generally oval-shaped outer casing portion, at least two inner-member portions, and at least one intermediate body portion fixedly attached to the outer casing and located intermediate of the outer casing and the inner-member portions, the outer casing structurally supports and encloses other thruster elements positioned therein, and the opposing surfaces of the casing portion, the at least two inner-member portions, and the at least one intermediate body portion define a closed-circuit fluid flow passage within the thruster;
a drive shaft supported for rotation in a given direction inside the outer casing by an arrangement of bearings;
at least one rotor secured for rotation with the drive shaft and lying in a plane normal to the rotational axis of the drive shaft, said rotor includes at least one central disk and a plurality of circumferentially arranged, low angle of attack, hydrofoil-like blades, each blade has an inner edge attached to the central disk, an outer edge, a leading edge, and a trailing edge, with each two successive blades being separated from each other by an intervening gap;
an incompressible viscous fluid completely filling the space enclosed within the outer casing;
means for sealing the space confined within the said outer casing; and at least one fluid expansion chamber.

2. The closed-circuit hydraulic thruster of claim 1, wherein the opposing surfaces of said intermediate-body and said outer casing define an outer annular passage therebetween, and with the opposing surfaces of said intermediate-body(s) and said inner-members define an inner annular passage therebetween, the inner annular passage has an upstream inflowing portion and a downstream outflowing portion, with the said rotor blades being positioned for rotation within the said inner annular passage, and with the said intermediate body being configured to allow the flow of the said incompressible viscous fluid from the said outer annular passage to the said upstream inflowing portion of the inner annular passage and from the said downstream outflowing portion of the inner annular passage to the said outer annular passage.

3. The closed-circuit hydraulic thruster of claim 2, wherein the downstream outflowing portion of the inner annular passage is provided with one set of circumferentially arranged vanes to align the flow of the working fluid with the contour of the downstream portion of the inner annular passage during operation.

4. The closed-circuit hydraulic thruster of claim 2, wherein the downstream outflowing portion of the inner annular passage is provided with more than one successive sets of circumferentially arranged vanes to decelerate the accelerated working fluid during operation, and then aligns its flow with the contour of the downstream portion of the inner annular passage.

5. The closed-circuit hydraulic thruster of claim 1, wherein the number of the blades of the said thruster's rotor ranges between 6 and 36 blades.

6. The closed-circuit hydraulic thruster of claim 1, wherein the ratio between the mean width of each of the said gaps intervening between each two successive blades and the mean Chord length of each of the said blades lies preferably anywhere within a range between 0.5:1 and 5:1, and more preferably between 1:1 and 4:1.

7. The closed-circuit hydraulic thruster of claim 1, wherein the successive parts of each of the blades of the said thruster's rotor have the same angle of attack, with the said angle of attack ranging preferably between 2 degrees and 14 degrees, and more preferably between 3 degrees and 8 degrees.

8. The closed-circuit hydraulic thruster of claim 1, wherein the successive parts of each of the blades of the said thruster's rotor have gradually increasing angles of attack from the blade's outer edge to the blade's inner edge, with said angles of attack lying preferably anywhere between 2 degrees and 14 degrees and more preferably between 3 degrees and 8 degrees.

9. The closed-circuit hydraulic thruster of claim 1, wherein the said drive shaft extends to a drive receiving end located outside the said casing, through which the driving torque is supplied during operation, with the said sealing means being positioned in-between the opposing surfaces of the drive shaft and the casing.

10. The closed-circuit hydraulic thruster of claim 1, wherein the said drive shaft is geared to another intermediate shaft, with the said intermediate shaft extending to a drive receiving end located outside the casing, through which the driving torque is supplied during operation, and with the said sealing means being positioned in-between the opposing surfaces of the intermediate shaft and the casing.

11. The closed-circuit hydraulic thruster of claim 1, wherein the said sealing means includes at least one O-ring seal; and a seal arrangement having at least one water-filled, generally torus-shaped, elastomeric tube, with the at least one elastomeric tube being co-axial with the thruster's drive shaft, and positioned relatively distal to the O-ring seal(s).

12. The closed-circuit hydraulic thruster of claim 11, wherein the said seal arrangement comprises: an inner ring, co-axial with the thruster's drive shaft, fixedly attached to the thruster's drive shaft, and having a circular concave groove formed on its circumferential outer surface; an outer generally ring-shaped portion, concentric with the inner ring, co-axial with the thruster's drive shaft, fixedly attached to the thruster's casing, and having a circular concave groove formed on its circumferential inner surface; and a water-filled, generally torus-shaped, elastomeric tube located within the space defined between the opposing surfaces of the circular concave groove formed on the circumferential outer surface of the inner ring and the circular concave groove formed on the circumferential inner surface of the outer ring-shaped portion, with the said elastomeric tube being pressly fitted to the circular concave groove formed on the circumferential inner surface of the outer ring-shaped portion.

13. The closed-circuit hydraulic thruster of claim 1, wherein the said sealing means includes at least two axially stacked sets of O-ring seals; and at least one seal arrangement having at least one water-filled, generally torus-shaped, elastomeric tube, with the at least one elastomeric tube being co-axial with the thruster's drive shaft, and positioned intermediate of two of the O-ring sets.

14. The closed-circuit hydraulic thruster of claim 13, wherein each of the said O-ring sets includes 1-3 successive O-rings.

15. The closed-circuit hydraulic thruster of claim 13, wherein the said seal arrangement comprises: an inner ring, co-axial with the thruster's drive shaft, fixedly attached to the thruster's drive shaft, and having a circular concave groove formed on its circumferential outer surface; an outer generally ring-shaped portion, concentric with the inner ring, co-axial with the thruster's drive shaft, fixedly attached to the thruster's casing, and having a circular concave groove formed on its circumferential inner surface; and a water-filled, generally torus-shaped, elastomeric tube located within the space defined between the opposing surfaces of the circular concave groove formed on the circumferential outer surface of the inner ring and the circular concave groove formed on the circumferential inner surface of the outer ring-shaped portion, with the said elastomeric tube being pressly fitted to the circular concave groove formed on the circumferential inner surface of the outer ring-shaped portion.

16. The closed-circuit hydraulic thruster of claim 13, wherein the space between the successive sets of O-rings, wherein the water-filled elastomeric tube(s) is positioned, is filled with a semisolid lubricant.

17. The closed-circuit hydraulic thruster of claim 1, wherein the said sealing means are fitted with heating means, to be used for warming up the sealing means before operating the thruster in relatively cold weather.

18. The closed-circuit hydraulic thruster of claim 17, wherein thermometer means are provided in at least one point, within or around the sealing means, and/or the heating means, to measure the temperature within the confines of the sealing means.

19. The closed-circuit hydraulic thruster of claim 1, wherein the fluid expansion chamber encloses a partially fluid-filled expansion space therein, and has one spring-loaded safety relief valve and one spring-loaded suction valve for controlling the fluid flow between the fluid expansion space and the space enclosed within the thruster's casing.

20. The closed-circuit hydraulic thruster of claim 19, wherein the fluid expansion chamber is completely sealed from surrounding atmosphere.

21. The closed-circuit hydraulic thruster of claim 19, wherein the fluid expansion chamber further has at least one passage for connecting it with the surrounding ambient air.

22. The closed-circuit hydraulic thruster of claim 19, wherein the fluid expansion chamber further has at least one spring-loaded safety relief valve, for controlling the release of the gases from the fluid expansion space once the pressure of gases within the fluid expansion space reaches to a preset value; and at least one spring-loaded suction valve, for controlling the admission of ambient air into the fluid expansion space once the pressure inside the fluid expansion space drops below a preset value.

23. The closed-circuit hydraulic thruster of claim 1, wherein the fluid expansion chamber comprises a first sub-chamber; and a second sub-chamber, the first sub-chamber is completely filled with fluid, and positioned intermediate of the second sub-chamber and the thruster's outer casing, the first sub-chamber has at least one spring-loaded safety relief valve and at least one spring-loaded suction valve for controlling the fluid flow between the first sub-chamber and the second sub-chamber; and at least one passage for connecting the space enclosed within the first sub-chamber with the space enclosed within the said outer casing, with the second sub-chamber being partially filled with fluid.

24. The closed-circuit hydraulic thruster of claim 23, wherein the second sub-chamber is completely sealed from surrounding atmosphere.

25. The closed-circuit hydraulic thruster of claim 23, wherein the second sub-chamber has at least one passage for connecting the space enclosed within it with the surrounding ambient air.

26. The closed-circuit hydraulic thruster of claim 23, wherein the second sub-chamber has at least one spring-loaded safety relief valve, for controlling the release of the gases from the second sub-chamber once the pressure of gases within the second sub-chamber reaches to a preset value; at least one spring-loaded suction valve, for controlling the admission of ambient air into the second sub-chamber once the pressure inside the second sub-chamber drops below a preset value.

27. The closed-circuit hydraulic thruster of claim 1, wherein the fluid expansion chamber includes at least one filter to prevent the ingestion of dirt, or dust, when ambient air is admitted to the fluid expansion chamber.

28. The closed-circuit hydraulic thruster of claim 1, which comprises more than one rotor, with each rotor being secured for rotation with the drive shaft, and with each rotor lying in a plane normal to the rotational axis of the said drive shaft.

29. The closed-circuit hydraulic thruster of claim 1; wherein means for cooling the said incompressible viscous fluid are provided.

30. The closed-circuit hydraulic thruster of claim 29, wherein the said means provided for cooling the said incompressible viscous fluid includes a plurality of cooling ribs on the outer surface of the said thruster's outer casing.

31. The closed-circuit hydraulic thruster of claim 29, wherein the said means provided for cooling the said incompressible viscous fluid includes a plurality of cooling ribs on the inner surface of the said thruster's outer casing.

32. The closed-circuit hydraulic thruster of claim 29, wherein the said means provided for cooling the said incompressible viscous fluid includes a forced air or fluid cooling arrangement.

33. The closed-circuit hydraulic thruster of claim 1, wherein the thrust force generated by the said thruster's rotor during operation is transmitted to the said thruster's casing through at least one thrust bearing arrangement.

34. The closed-circuit hydraulic thruster of claim 1, wherein the said torque provided by the said prime mover, or electric motor, is transmitted to the said thruster's drive shaft through a gear train arrangement.

35. The closed-circuit hydraulic thruster of claim 1, which is fixedly attached to the main frame of the propelled vehicle.

36. The closed-circuit hydraulic thruster of claim 1, which is pivotally attached to the main frame of the propelled vehicle, with means for changing the direction in which the developed thrust/lift force is applied during operation being provided.
